(19) United States
(12) Patent Application Publication
(10) Pub. No.: US 2026/0340188 A1
(43) Pub. Date: Oct. 29, 2026

(54) CRYPTOGRAPHIC SOLUTIONS FOR DETECTING AND SECURING SENSITIVE DATA

(71) Applicant: GOVERNMENT EMPLOYEES INSURANCE COMPANY (GEICO), Fredericksburg, VA (US)

(72) Inventors: Darek BLASIAK, Park Ridge, IL (US); Priyanka MEHTA, San Francisco, CA (US); Tran NGUYEN, Flagstaff, AZ (US); Malan CHAKRAVARTHI, Oceanside, CA (US)

(21) Appl. No.: 19/193,640

(22) Filed: Apr. 29, 2025

(51) Int. Cl. G06F 21/62; G06F 21/60

(52) U.S. Cl. CPC G06F 21/6254; G06F 21/602

(57) ABSTRACT

Provided herein are system, apparatus, device, method and/or computer program product embodiments, and/or combinations and sub-combinations thereof, for rapidly detecting and applying a corrective action on sensitive data using a detection model. The sensitive data may be personally identifiable information (PII) data. The detection model is trained with training encoded data that comprises encoded sensitive data. Encoding of sensitive data is achieved by utilizing a one-way encoding function that cryptographically converts sensitive data to codewords. An embodiment operates by a computing system receiving a training raw dataset with sensitive data, encodes the training raw dataset using a one-way encoding function to generate a training encoded dataset, and trains a detection model based on the training encoded dataset. The computing system further uses the detection model on a target encoded dataset to detect and apply a corrective action on sensitive data in the target dataset.

### FIELD

The technology relates to systems and methods for obscuring intelligible information (such as PII). Techniques for detecting certain types of sensitive information (such as data descriptors and PII) are also disclosed.

### BACKGROUND

Organizations often collect sensitive data from their customers and store the sensitive data into databases. Examples of sensitive data may include personally identifiable information (PII). To protect their customers, organizations often apply a corrective action to the sensitive data from the databases to prevent unauthorized access or disclosure, or when there is no business reason to retain the information. However, manually applying a corrective action (e.g., obfuscating, encrypting, encoding, deleting, hashing, etc.) to the sensitive data is time consuming and prone to human error. Moreover, using computer program such as a machine learning model to detect and applying the corrective action to sensitive data requires training the model with sensitive data, which poses a security risk of generating a detection model containing sensitive data.

### BRIEF DESCRIPTION OF THE DRAWINGS

The accompanying drawings are incorporated herein and form a part of the specification.

FIG. 1 is a block diagram of a system for detecting and applying a corrective action to sensitive data in a target raw dataset, according to some embodiments.

FIG. 2 is a flowchart illustrating a process for training a detection model using a training encoded dataset, according to some embodiments.

FIG. 3A is a flowchart illustrating a process for detecting and applying a corrective action to sensitive data in a target raw dataset using a detection model, according to some embodiments.

FIG. 3B is a flowchart illustrating an alternative process for detecting and applying a corrective action to sensitive data in a target raw dataset using a detection model, according to some embodiments.

FIG. 4 is a flowchart illustrating a process for preparing input data for a detection model, according to some embodiments.

FIG. 5A is a block diagram illustrating how a data encoder may convert a raw dataset to an encoded dataset for a detection model, according to some embodiments.

FIG. 5B is a block diagram illustrating another example of how a data encoder may convert a raw dataset to an encoded dataset for a detection model, according to some embodiments.

FIG. 6 is a block diagram illustrating how a data encoder may encode a data pair using a one-way encoding function and a two-way context encoding function, according to some embodiments.

FIG. 7 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for rapidly detecting and applying a corrective action to sensitive data, such as personally identifiable information (PII) data, using a detection model. The detection model is not directly trained on sensitive data—instead, it is trained on training data that comprises encoded sensitive data. This means the sensitive data is not exposed during training of the detection model, which avoids creating security risks. Specifically, the sensitive data is encoded using a one-way encoding function (e.g., a mathematical process that irreversibly changes the value of the data). The one-way encoding function that cryptographically converts sensitive data to codewords. Because the detection model is trained with data encoded by the one-way encoding function, the underlying sensitive data used to train the model cannot be retrieved, the reason being that a one-way encoding function by mathematical definition cannot be reversed to obtain the original data.

Organizations often collect sensitive data, such as PII data, from their customers and store the sensitive data into databases. Examples of PII data may include, but not limited to, name, address, social security number (SSN), individual taxpayer identification number (ITIN), email address, phone number, date of birth, biometric data, date of birth, passport number, password, financial account numbers, driver's license number, license plate, medical records, associate identification (ID), user ID, claim number, client number, policy number, credit score, card verification value (CVV), IP address, vehicle identification number (VIN), etc. To protect their customers, organizations may obfuscate sensitive data from the databases to prevent unauthorized access or inadvertent disclosure, or when there is no business reason to retain the information. Sensitive data may be stored in structured and/or unstructured forms along with other non-sensitive data. Manually applying a corrective action to sensitive data requires detecting sensitive data from all the existing data in various data storages, which is time consuming and prone to human error. Moreover, using a computer program such as a machine learning model to detect and correct sensitive data using real sensitive data poses a security risk of revealing real sensitive data to the model.

Embodiments herein utilize a one-way encoding function to encode sensitive data for securely training a detection model, which enables training the detection model without exposing the sensitive data. This is because the one-way encoding function irreversibly changes the value of the data, so that the detection model cannot reverse the encoded sensitive data to obtain the real sensitive data. Accordingly, the real sensitive data is protected from the model and customer's privacy is preserved.

The embodiments herein for detecting and applying a corrective action to sensitive data also provide various advantages, including improving performance of computing devices running the detection model. The provided technology can detect and apply the corrective action to the sensitive data with high accuracy and speed. A specially designed one-way encoding function encodes the training data for training the detection model. The same one-way encoding function is also used to encode the target data, which are provided to the trained detection model to detect encoded sensitive data in the encoded target data. Since the specially designed one-way encoding function simplifies the data and in the meantime preserves the patterns of the data, the training and inference cost is minimized. Additionally, the sensitive data detection system can be implemented using CPUs and achieves similar performance to a system implemented using Graphics Processing Units (GPUs), therefore reducing the hardware cost for implementing the system.

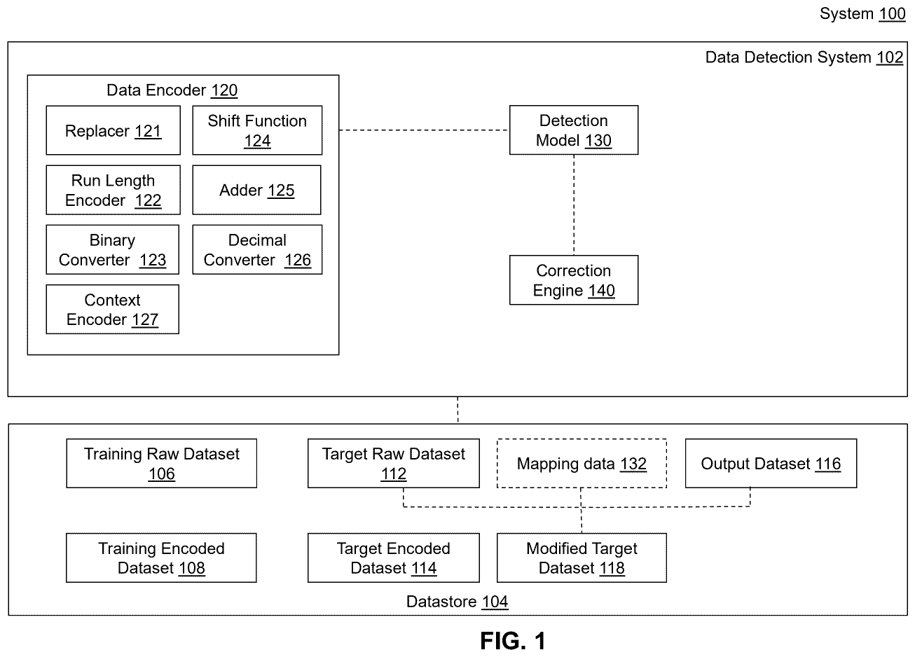

FIG. 1 is a block diagram of a system 100 for detecting and applying a corrective action to sensitive data, such as PII data, in a target dataset, according to some embodiments. System 100 may be a cloud-computing platform. System 100 may be a private cloud-computing platform. System 100 may be a hosted system. System 100 may be various other types of software/hardware platforms as would be appreciated by a person of ordinary skill in the art.

System 100 may include data detection system 102 and datastore 104. Data detection system 102 may include data encoder 120, detection model 130, and correction engine 140. In some embodiments, data detection system 102 may be implemented on a server computer, virtual machine, container, cloud computing platform, or other device as would be appreciated by a person of ordinary skill in the art.

Data detection system 102 may access data in datastore 104. For example, data detection system 102 may access training raw dataset 106 and target raw dataset 112 stored in datastore 104. In some embodiments, training raw dataset 106 may be in a structured format (e.g., a table), and may include a plurality of training raw data entries and one or more training dataset descriptors (DSDs). Each training DSD may describe a column of training raw data entries in training raw dataset 106. Similarly, target raw dataset 112 may be in a structured format (e.g., a table) and may include a plurality of target raw data entries and one or more target DSDs. Each target DSD may describe a column of target raw data entries in target raw dataset 112. Both training raw data entries and target raw data entries may include sensitive data such as PII data, and/or non-sensitive data, such as non-PII (NPII). Each PII, NPII, training DSD, and target DSD may be one or more characters including numbers, alphabets, special characters, or a combination thereof.

Data detection system 102 may also generate, store and/or update data in datastore 104. Examples of such data may include training encoded dataset 108, target encoded dataset 114, and output dataset 116. In some embodiments, training encoded dataset 108 is in a structured format (e.g., a table) and stores training raw data entries in an encoded format. For example, each row of training encoded dataset 108 stores a training codeword. The training codeword may include two component codewords, one component codeword is encoded from a training raw data entry of training raw dataset 106, and the other component codeword is encoded from a training DSD corresponding to the training raw data entry. In some embodiments, target encoded dataset 114 is in a structured format (e.g., a table) and stores target raw data entries in an encoded format. For example, each row of target encoded dataset 114 stores a target codeword. The target codeword may include two component codewords, one component codeword is encoded from a target raw data entry of target raw dataset 112 and the other component codeword is encoded from a target DSD corresponding to the target raw data entry. In some embodiments, both training encoded dataset 108 and target encoded dataset 114 may include encoded sensitive data, e.g., encoded PII data. As will be explained in details later, a training codeword includes encoded sensitive data if it includes a component codeword of a training raw data entry containing sensitive data. And the encoded sensitive data exclude sensitive data itself. In other words, sensitive data cannot be derived from the encoded sensitive data since a one-way encoding function is used to obtain the encoded sensitive data.

In some embodiments, a codeword, such as the training codeword, or the target codeword, is generated by applying an encoding function on a raw data entry, e.g., a training raw entry or a target raw data entry. The codeword may be a vector of integers of length L and L is an integer value greater than 0.

In some embodiments, data detection system 102 may generate mapping data 132 which maps a location of a target codeword in target encoded dataset 114 to a location of a target raw data entry in target raw dataset 112.

In some embodiments, data detection system 102 may delete certain data when they are no longer needed. For example, after training detection model 130, data detection system 102 may delete training raw dataset 106 and training encoded dataset 108. Similarly, after generating modified target dataset 118, data detection system 102 may delete output dataset 116 and mapping data 132.

It is to be appreciated that datastore 104 may store datasets in databases. In some embodiments, datastore 104 may be implemented on a server computer, virtual machine, container, cloud computing platform, or other device as would be appreciated by a person of ordinary skill in the art.

Data Encoder 120 may encode a raw dataset to generate an encoded dataset using a one-way encoding function and a two-way context encoding function. The one-way encoding function irreversibly encodes a raw data entry of the raw dataset to a codeword of the encoded dataset so that the original value of the raw data entry cannot be derived from the codeword. In other words, there is no decoding function corresponding to the one-way encoding function.

In some embodiments, the raw dataset may be training raw dataset 106 with sensitive data (e.g., PII data), and the encoded dataset is training encoded dataset 108, which includes a plurality of training codewords. Each training codeword includes a component codeword encoded from a training raw data entry of training raw dataset 106 using the one-way encoding function, and a component codeword encoded from a training DSD using the two-way context encoding function. Training encoded dataset 108 excludes sensitive data. A training codeword may include encoded sensitive data, if it includes a component codeword encoded from a training raw data entry containing sensitive data, but the sensitive data cannot be derived from the encoded sensitive data due to the nature of the one-way encoding function.

Data detection system 102 may divide training encoded dataset 108 into multiple non-overlapping training encoded data subsets, and use the training encoded data subsets to train and evaluate detection model 130. In some embodiments, data detection system 102 may divide training raw dataset 106 into multiple non-overlapping training data subsets before using data encoder 120 to generate training encoded data subsets. Data detection system 102 may use a first training encoded data subset to train detection model 130 and to update parameters of detection model 130, which is an updated detection model. A second training encoded data subset may be used to evaluate the updated detection model. During the evaluation process, detection model 130 may perform detection (e.g., prediction of sensitive data) on the second training encoded data subset. The evaluation process may include generating a performance measurement and comparing the performance measurement with a predefined performance threshold. In some embodiments, data detection system 102 completes the training of detection model 130 if the performance measurement is greater than or equal to the predefined performance threshold. In some embodiments, completes the training may refer to generating detection model 130 with updated parameters that can be used on target datasets. It is to be appreciated that parameters of detection model 130 may be internal variables that detection model 130 learns from training datasets to make predictions. If the performance measurement is less than the predefined performance threshold, the training process may be continued using a third training encoded data subset.

In some embodiments, the predefined performance threshold may be different for different sensitive data types (or PII types). For example, each sensitive data type is assigned a different weight, e.g., a sensitive data type of SSN may have a higher weight. Examples of sensitive data type may include, but not limit to, name, address, SSN, ITIN, email address, phone number, date of birth, biometric data, date of birth, passport number, password, financial account numbers, driver's license number, license plate, medical records, associate ID, user ID, claim number, client number, policy number, credit score, CVV, IP address, VIN. In some embodiments, sensitive data types are derived from DSDs.

In some embodiments, the raw dataset may be target raw dataset 112 and the encoded dataset is target encoded dataset 114. Target encoded dataset 114 includes a plurality of target codewords. Each target codeword includes a component codeword encoded from a target raw data entry of target raw dataset 112 using the one-way encoding function, and a component codeword encoded from a target DSD using the two-way context encoding function. Target encoded dataset 114 may include encoded sensitive data (e.g., encoded PII data). Since sensitive data cannot be derived from encoded sensitive data, sensitive data are not revealed to detection model 130. Detection model 130 may perform sensitive data detection on target encoded dataset 114 to generate output dataset 116. A sensitive data detection on target encoded dataset 114 may refer to detecting a target codeword that contains encoded sensitive data, e.g., a target codeword that contains a component codeword that is encoded from a target raw data entry containing sensitive data.

In some embodiments, the raw dataset (e.g., training raw dataset 106 or target raw dataset 112) may be in a structured form (e.g., a table) with one or more rows of raw data entries, and one or more columns. Each of the one or more columns is identified by a DSD. A raw data entry in the raw dataset may be one or more characters including numbers, alphabets, special characters, or a combination thereof. The location of a raw data entry in the table is uniquely identified by a row number and a DSD, e.g., a 2-tuple (Row_Number, DSD), where Row_Number is a row number associated with the raw data entry in the raw dataset and DSD is a DSD identifying a column associated with the raw data entry in the raw dataset. Data encoder 120 may convert the raw dataset into a desired format before encoding the raw dataset. For example, Data encoder 120 may convert each raw data entry of the raw dataset into a data pair represented by a 2-tuple (Raw_Data_Entry, DSD), where Raw_Data_Entry is the respective raw data entry of the raw dataset and DSD is a DSD associated with the raw data entry.

After converting the raw dataset into a set of data pairs, where each data pair is represented by a 2-tuple (Raw_Data_Entry, DSD), data encoder 120 may encode the set of data pairs using the one-way encoding function and the two-way context encoding function to generate an encoded dataset (e.g., training encoded dataset 108 or target encoded dataset 114). For example, for each data pair of the set of data pairs, data encoder 120 encodes the Raw_Data_Entry using the one-way encoding function to generate a codeword for Raw_Data_Entry, and encodes DSD using the two-way context encoding function to generate a codeword for DSD. In some embodiments, data encoder 120 adds data paddings (e.g., zeros) for the codeword for Raw_Data_Entry and context paddings (e.g., zeros) for the codeword for DSD, and concatenates the padded codeword for Raw_Data_Entry and the padded codeword for DSD to generate a codeword for the respective data pair. Here both the codeword for Raw_Data_Entry and the codeword for DSD may be referred to as component codewords of the codeword for the respective data pair.

In some embodiments, the encoded dataset is training encoded dataset 108, and the codeword for each data pair is a training codeword. The training codeword includes two component codewords, one is a codeword (or a padded version) for a training raw data entry of training raw dataset 106, and the other is a codeword (or a padded version) for a training DSD of training raw dataset 106. In some embodiments, the encoded dataset is target encoded dataset 114, and the codeword for the each data pair is a target codeword. The target codeword also includes two component codewords, one is a codeword (or a padded version) for a training raw data entry of target raw dataset 112, and the other is a codeword (or a padded version) for a training DSD of target raw dataset 112.

In some embodiments, data encoder 120 may generate the codeword for Raw_Data_Entry using the following one-way encoding function. Data encoder 120 uses replacer 121 to replace characters in Raw_Data_Entry with integer values using a one-way mapping function and generate a string of integer values. The one-way mapping function may irreversibly map input characters into output data so that input characters cannot be derived based on the output data. In some embodiments, the one-way mapping function may replace each upper case letter character to the American Standard Code for Information Interchange (ASCII) value of “A”, i.e., 65, each lower case letter character to the ASCII value of “a”, i.e., 17, and each numeric character to the ASCII value of “0”, i.e., 48. Additionally, each special character may be replaced with its unique ASCII values, e.g., special character “@” is replaced with 64, special character “.” is replaced with 46, etc. Once the characters in Raw_Data_Entry are mapped to the string of integer values using the one-way mapping function, the original value of Raw_Data_Entry cannot be derived from the string of integer values.

In some embodiments, data encoder 120 may use run length encoder 122 to generate a set of integer pairs from the string of integer values. Run length encoder 122 may use a run-length encoding algorithm, which may be a lossless data compression technique that replaces consecutive sequences of the same data value with a single value and a count of how many times it repeats. For example, each integer pair of the set of integer pairs includes a replaced character value and a character count. To obtain the replaced character values and the character counts, run length encoder 122 traverses through the string of integer values, sets the first integer value as a first replaced character value, and counts the number of consecutive first replaced character value as a first character count for the first replace character value. The process continues until the end of the string of integer values. Data encoder 120 may use binary converter 123 to convert each integer pair of the set of integer pairs into a binary format and use shift function 124 to shift the binary format of the replaced character value of each integer pair a predetermined number of places to the left. For each integer pair of the set of integer pairs, adder 125 may sum the shifted binary format of the replaced character value and the binary format of the character count of the each respective integer pair, and decimal converter 126 may convert the summed binary format into a decimal format to generate the codeword for Raw_Data_Entry. In some embodiments, the predetermined number of places may be at least the maximum number of binary bits required to represent the character count. In some embodiments, the maximum number of binary bits may be the number of binary bits that is needed to represent the maximum value of the character count, so that the bits in the shifted binary format of the replaced character value do not overlap with the bit in the binary format of the character count of the respective integer pair.

In some embodiments, data encoder 120 may include context encoder 127 to generate the codeword for DSD using a two-way context encoding function. The two-way context encoding function allows decoding the codeword for DSD to reveal the value of the DSD. In some embodiments, context encoder 127 may find a plurality of unique words from each DSD of all or most of the DSDs of the entire raw dataset, each word may be a collection of alphabetical characters without any special characters or punctuation. Context encoder 127 may then sort the unique words in order of frequency, and assign each word a unique numeric value. Once this mapping of words to numeric values is constructed, the DSD may be encoded by mapping the words in the DSD with unique numeric values.

In some embodiments, data encoder 120 and each of its modules, such as replacer 121, run length encoder 122, binary converter 123, shift function 124, adder 125, decimal converter 126, context encoder 127, may be implemented on a server computer, virtual machine, container, cloud computing platform, or other device as would be appreciated by a person of ordinary skill in the art.

In some embodiments, the raw dataset is target raw dataset 112 and the encoded data set is target encoded dataset 114. Each row of target encoded dataset 114 stores a target codeword encoded from a target raw data entry of target raw dataset 112 and a target DSD. Data encoder 120 may generate mapping data 132 that maps each row of target encoded dataset 114 (e.g., a target codeword) to a location of a target raw data entry in target raw dataset 112. The location of the target raw data entry in target raw dataset 112 may be represented by a 2-tuple (Target_Row_Number, Target_DSD), where Target_Row_Number is a row number of the target raw data entry in target raw dataset 112, and Target_DSD is a target DSD associated with the target raw data entry. Mapping data 132 may be used to identify sensitive data in target raw dataset 112.

For example, if it is determined that a target codeword (identified by a row number in target encoded dataset 114) contains encoded sensitive data, e.g., the target codeword includes a component codeword that is encoded from a target raw data entry in target raw dataset 112 containing sensitive data, mapping data 132 can be used to identify the target raw data entry in target raw dataset 112.

In some embodiments, data encoder 120 may store encoded datasets in datastore 104, such as training encoded dataset 108 and target encoded dataset 114. In some embodiments, data detection system 102 may train detect model 130 using training encoded dataset 108. After training, detection model 130 may detect encoded sensitive data (e.g., encoded PII data) in target encoded dataset 114. For example, detection model 130 may detect a subset of target codewords in target encoded dataset 114, and each target codeword is predicted by detection model 130 as containing encoded sensitive data. In other words, each target codeword includes a component codeword encoded from a target raw data entry containing sensitive data. The subset of target codewords are stored in a subset of rows in target encoded dataset 114.

In some embodiments, detection model 130 may calculate a confidence level for each prediction of a target codeword containing encoded sensitive data, i.e., whether the target codeword includes a component code that is encoded from a target raw data entry containing sensitive data. In some embodiments, the confidence level may quantify the certainty that the detection model 130 has in its prediction, wherein the confidence level may range from 0 to 1. Detection model 130 may determine the target codeword contains encoded sensitive data if the confidence level is above a threshold value. A threshold value may be a specific point or level that marks a change in behavior or condition. In some embodiments, the threshold value may be used to convert the prediction confidence level to a binary class label, e.g., positive or negative. A positive prediction may mean the target codeword contains encoded sensitive data. The threshold value may be configurable. Detection model 130 may also classify each target codeword by a sensitive data type, which identifies a sensitive data type in a target raw data entry that is encoded into a component codeword of the target codeword. Detection model 130 may save the row numbers of target encoded dataset 114 indicating the subset of target codewords, as well as their associated sensitive data types to output dataset 116.

In some embodiments, detection model 130 may be an Extreme Gradient Boosting (XGBoost) model that uses gradient descent to optimize decision trees. As would be appreciated by a person of ordinary skill in the art, XGBoost is an open source machine learning library. Examples of XGBoost implementations are described in “XGBoost with Python: Gradient Boosted Trees with XGBoost and scikit-learn” by Jason Brownlee, the disclosure of which is incorporated by reference in its entirety herein.

Correction engine 140 may apply a corrective action against target raw data entries containing sensitive data in target raw dataset 112. A corrective action may include masking, redaction, encryption, obfuscation or removing a data entry in a dataset, raising security levels on the dataset, or deleting the dataset. In some embodiments, masking may refer to a process of transforming sensitive data into a non-sensitive substitute. Redaction may refer to a process of concealing sensitive data by masking, blacking out, and/or replacing it with placeholder text. Encryption may refer to a process of converting sensitive data into an unreadable format using a key that only people with correct key can decrypt it back into its original readable format. Obfuscation may refer to a process of transforming sensitive data into a format that is difficult for unauthorized users to understand or interpret. Some obfuscation techniques may include masking, encryption, hashing, and/or randomization. In some embodiments, raising the security level on the dataset may refer to a process of only allowing an authorized user with a higher security level to access the dataset.

In some embodiments, correction engine 140 may use output of detection model 130 (e.g., output dataset 116) to identify target raw data entries of target raw dataset 112 that contain sensitive data, and apply the corrective action against the identified target raw data entries in target raw dataset 112. In some embodiments, mapping data 132 may be used in additional to output dataset 116 to identify target raw data entries containing sensitive data in target raw dataset 112. For example, correction engine 140 may retrieve output dataset 116 and mapping data 132 from datastore 104, locate target raw data entries of target raw dataset 112 that contain sensitive data based on output dataset 116 and mapping data 132, and apply the corrective action against identified target raw data entries in target dataset 112 to generate modified target dataset 118. In some embodiments, the corrective action may use common data obfuscation techniques, and the modified target dataset 118 may be an obfuscated target dataset. More generally, a modified dataset is a dataset that has been altered by one or more corrective actions, such as obfuscating a data entry comprising PII. Additionally, modifying a data entry may comprise applying a corrective action on a data entry.

In some embodiments, output dataset 116 may include a set of row numbers of target encoded dataset 114. Each row identifies a target codeword of target encoded dataset 114 that contains encoded sensitive data. In other words, each row identifies a target codeword contains a component codeword that is encoded from a target raw data entry of target raw dataset 112 containing sensitive data. Since mapping data 132 stores a mapping between a row number of target encoded dataset 114 and a location of a target raw data entry in target raw dataset 112, a row number in output dataset 116 can be used to identify a location of a target raw data entry containing sensitive data in target raw dataset 112. Here a location of a target raw data entry in target raw dataset 112 is represented by a 2-tuple (Target_Row_Number, Target_DSD), where Target_Row_Number is the row number of the target raw data entry in target raw dataset 112, and Target_DSD is a target DSD associated with the target raw data entry in target raw dataset 112.

After identifying a plurality of target raw data entries containing sensitive data in target raw dataset 112 using output dataset 116 and mapping data 132, correction engine 140 may apply the corrective action against the identified target raw data entries in target raw dataset 112 to generate modified target dataset 118. For other target raw data entries that are not identified as containing PII, it may be assumed that they are target raw data entries that contain NPII. Accordingly, correction engine 140 may skip applying the corrective action to those target raw data entries. In some embodiments, correction engine 140 may only apply the corrective action to identified target raw data entries, which may implicitly skip applying the corrective action to other target raw data entries not identified as containing sensitive data. In one example, the corrective action is an obfuscation action, and a phone number may be replaced by (XXX) XXX-XXXX by correction engine 140. In some embodiments, data detection system 102 may replace target raw dataset 112 with modified target dataset 118 in datastore 104. In some embodiments, data detection system 102 may delete output dataset 116 and mapping data 132 after generating modified target dataset 118.

In some embodiments, data encoder 120 may encode one column of target raw data entries in target raw dataset 112 at a time, e.g., to generate a plurality of target codewords for the target raw data entries of the column in target raw dataset 112, and run detection model 130 on the plurality of target codewords. If detection model 130 detects that the plurality of target codewords contain encoded sensitive data, e.g., e.g., the column of target raw data entries in target raw dataset 112 contain sensitive data, it classifies the target raw data entries of the column as sensitive data and by a type of sensitive data, outputs the type of sensitive data, which may be saved to output dataset 116. Data detection system 102 may add the type of sensitive data associated with the column to metadata of target raw dataset 112. The metadata of target raw dataset 112 may be stored in a separate database accessible to data detection system 102.

In some embodiments, correction engine 140, or a separate module of data detection system 102 may update the metadata of target raw dataset 112 by adding a tag indicating the type of sensitive data to the column of target raw dataset 112 that is classified as sensitive data. Correction engine 140 may retrieve the metadata of target raw dataset 112 and apply a corrective action against one or more of columns that are tagged as sensitive data. It should be apparent to those of ordinary skill in the art that data detection system 102 may be implemented using a parallel architecture, so that multiple columns of data records in target raw dataset 112 may be encoded, detected and modified by a corrective action in parallel.

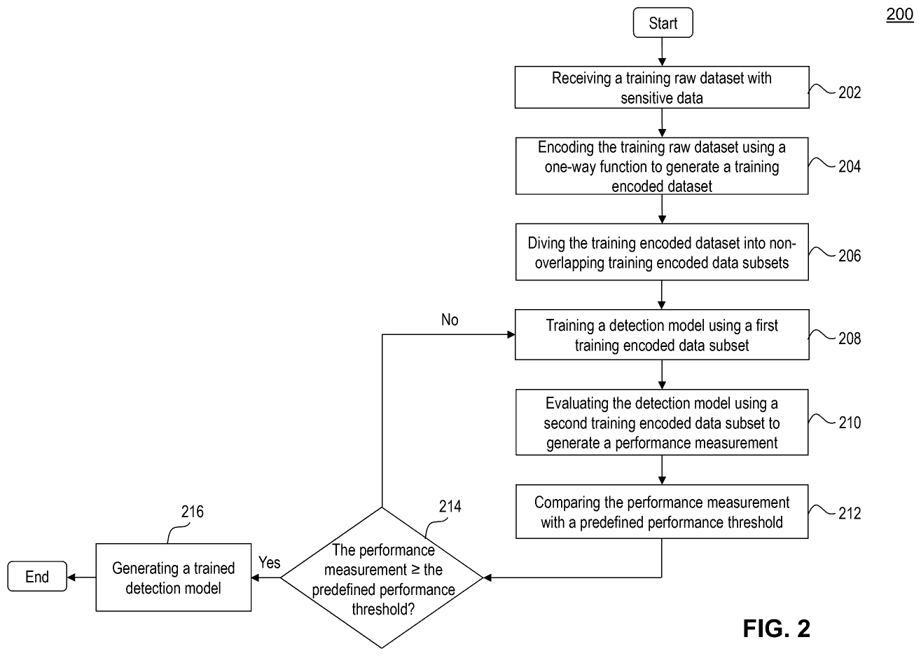

FIG. 2 is a flowchart for a method 200 for training a detection model using a training encoded dataset, according to some embodiments. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art.

Method 200 shall be described with reference to FIGS. 1 and 2. However, method 200 is not limited to that example embodiment.

In 202, data detection system 102 receives training raw dataset 106. Training raw dataset 106 may be in a structured format (e.g., a table) including a plurality of training raw data entries and one or more training DSDs. A training raw data entry may include sensitive data (e.g., PII), or non-sensitive data (e.g., NPII). Each PII, NPII and training DSD may be one or more characters including numbers, alphabets, special characters, or a combination thereof. Training raw dataset 106 may be stored in datastore 104.

In 204, data encoder 120 encodes training raw dataset 106 using a one-way encoding function and a two-way context encoding function to generate training encoded dataset 108. In some embodiments, training encoded dataset 108 is in a structured format (e.g., a table) and stores training raw data entries in an encoded format. For example, each row of training encoded dataset 108 stores a training codeword for a training raw data entry of training raw dataset 106 and a training DSD. The training codeword is generated by concatenating a component codeword encoded from a training raw data entry of training raw dataset 106 using the one-way encoding function, and a component codeword encoded from the training DSD using the two-way context encoding function. In some embodiments, both component codewords are padded with zeros before being concatenated. In some embodiments, the training codeword may be a vector of integers of length L_{training} and L_{training} is an integer value greater than 0.

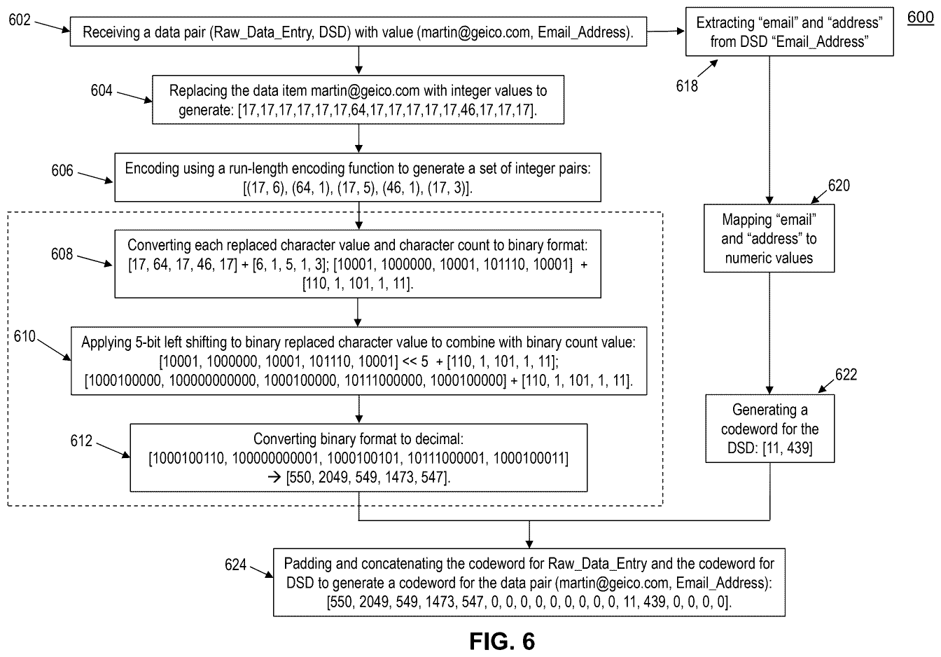

If the training raw data entry contains sensitive data, the training codeword contains encoded sensitive data. However, the original sensitive data cannot be derived from the encoded sensitive data since one-way encoding function is irreversible. Accordingly, training encoded dataset 108 excludes sensitive data. Additionally, the one-way encoding function preserves the patterns of the training raw data while simplifies the data, which reduces the cost of training the detection model. Details of the one-way encoding function will be described in FIG. 6. Further in 204, data detection system 102 may store training encoded dataset 108 in datastore 104.

In some embodiments, training raw dataset 106 may be a table with rows of training raw data entries, and one or more columns. Each column is identified by a training DSD. The location of a training raw data entry in training raw dataset 106 may be uniquely identified by a 2-tuple (Row_Number, Training_DSD), where Row_Number is a row number associated with the training raw data entry in training raw dataset 106 and Training_DSD is a training DSD identifying a column associated with the training raw data entry. Data encoder 120 may convert training raw dataset 106 into a desired format before encoding. For example, data encoder 120 may convert each training raw data entry of training raw dataset 106 into a data pair represented by a 2-tuple (Raw_Data_Entry, Training_DSD), where Raw_Data_Entry is the respective training raw data entry of training raw dataset 106, and Training_DSD is a training DSD associated with the respective training raw data entry. After training raw dataset 106 is converted into a set of data pairs, data encoder 120 may encode the set of data pairs using the one-way encoding function and the two-way context encoding function to generate training encoded dataset 108.

In 206, data detection system 102 divides training encoded dataset 108 into multiple non-overlapping training encoded data subsets for training and evaluating detection model 130. In some embodiments, training raw dataset 106 may be divided into multiple non-overlapping training raw data subsets before being encoded into non-overlapping training encoded data subsets.

In 208, data detection system 102 uses a first training encoded data subset to train detection model 130. The first training encoded data subset may include encoded sensitive data, e.g., a training codeword of the training encoded dataset includes a component codeword that is encoded from a training raw data entry of training raw dataset 106 containing sensitive data. Detection model 130 uses the first training encoded data subset to learn and update parameters of detection model 130 to generate an updated detection model. In some embodiments, detection model 130 may be an XGBoost model and implements gradient boosting algorithms for training. It is to be appreciated that XGBoost is an open source machine learning library available in multiple programming languages, such as C++, Python, R, Java, Julia, Perl, and Scala, etc. Examples of XGBoost implementations are described in https://github.com/dmlc/xgboost.

In 210, data detection system 102 uses a second training encoded data subset to evaluate the performance of detection model 130. During the evaluation process, detection model 130 may perform detection (e.g., prediction of sensitive data) on a known dataset. For example, data detection system 102 may apply detection model 130 with updated parameters on the second training encoded data subset to generate a performance measurement. The performance measurement of detection model 130 may be based on a precision value and a recall value. The precision value measures the detection accuracy of the model, or the accuracy of positive predictions, e.g., the ratio of number of correct sensitive data predictions over total number of sensitive data predictions. The recall value measures the detection rate of the model. In other words, the model's ability of identify all relevant sensitive data, e.g., the ratio of number of correct sensitive predictions over total number of sensitive data. A sensitive data prediction is a prediction of a training codeword in the training encoded data subset containing encoded sensitive data by the detection model. The performance measurement may be derived based on both the precision value and the recall value. In some embodiments, the performance measurement is a harmonic mean of the precision value and the recall value. Other functions may be used to derive the performance measurement as would be appreciated by a person of ordinary skill in the art.

In 212 data detection system 102 compares the performance measurement with a predefined performance threshold. In one example, the predefined performance threshold is 0.9. In some embodiments, the predefined performance threshold may be different for different sensitive data type. For example, each sensitive data type is assigned a different weigh, e.g., a sensitive data type of SSN may have a higher weight.

In 214, if the performance measurement is greater or equal to the predefined performance threshold, method 200 continues at step 216. Otherwise, if the performance measurement is less than the predefined performance threshold, method 200 continues at step 208.

In 216, data detection system 102 completes the training process and generates trained detection model 130.

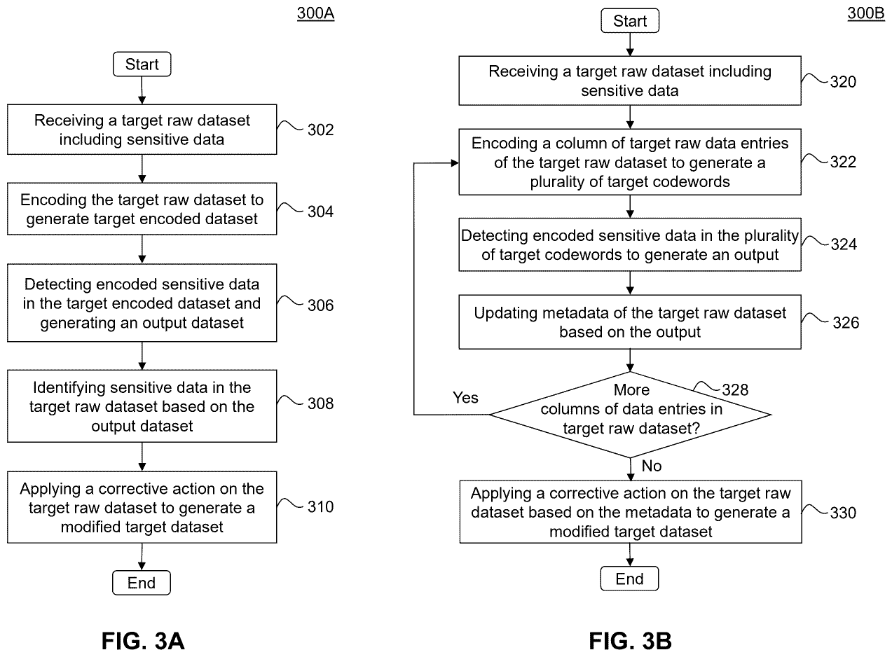

FIG. 3A is a flowchart for a method 300A for detecting and applying a corrective action to sensitive data in a target raw dataset using a detection model, according to some embodiments. Method 300A can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3A, as will be understood by a person of ordinary skill in the art.

Method 300A shall be described with reference to FIGS. 1 and 3A. However, method 300A is not limited to that example embodiment.

In 302, data detection system 102 receives target raw dataset 112. Target raw dataset 112 may be in a structured format (e.g., a table) including a plurality of target raw data entries and one or more target DSDs. A target raw data entry of target raw dataset 112 may include sensitive data (e.g., PII), or non-sensitive data, (e.g., NPII). Each PII, NPII and target DSD may be one or more characters including numbers, alphabets, special characters, or a combination thereof. Target raw dataset 112 may be stored in datastore 104.

In 304, data encoder 120 encodes target raw dataset 112 using a one-way encoding function and a two-way context encoding function to generate target encoded dataset 114. In some embodiments, target encoded dataset 114 is in a structured format (e.g., a table) and stores target raw data entries of target raw dataset 112 in an encoded format. For example, each row of target encoded dataset 114 stores a target codeword for a target raw data entry of target raw dataset 112 and a target DSD. Each target codeword is generated by concatenating a component codeword encoded from a target raw data entry of training raw dataset 106 using the one-way encoding function, and a component codeword encoded from the DSD using the two-way context encoding function. In some embodiments, both component codewords are padded with zeros before being concatenated. The same one-way encoding function and two-way context encoding function as used in step 204 of FIG. 2 are used here. In some embodiments, the target codeword may be a vector of integers of length L_{target} and L_{target} is an integer value greater than 0.

If a target raw data entry of target raw dataset 112 contains sensitive data, a target codeword including a component codeword encoded from the target raw data entry contains encoded sensitive data, e.g., encoded PII data. Therefore, target encoded dataset 114 may comprise encoded sensitive data. Since encoding is based on the same one-way encoding function as described in step 204 of FIG. 2, target encoded dataset 114 will not reveal the real sensitive data to detection model 130.

In some embodiments, target raw dataset 112 may be a table with one or more rows of target raw data entries, and one or more columns. Each column is identified by a target DSD. The location of a target raw data entry in target raw dataset 112 may be identified by a 2-tuple (Target_Row_Number, Target_DSD), where Target_Row_Number is a row number associated with the target raw data entry and Target_DSD is a target DSD identifying a column associated with the target raw data entry. Data encoder 120 may convert target raw dataset 112 into a desired format. For example, data encoder 120 may convert each target raw data entry of target raw dataset 112 into a data pair represented by a 2-tuple (Target_Raw_Data_Entry, Target_DSD), where Target_Raw_Data_Entry is the respective target raw data entry and Target_DSD is a target DSD associated with the respective target raw data entry. When one or more target raw data entries are converted to one or more data pairs, data encoder 120 may encode the one or more data pairs using the same one-way encoding function and the same two-way context encoding function as described in step 204 of FIG. 2 to generate target encoded dataset 114.

In some embodiment, target encoded dataset 114 may be a table with one or more rows, and each row stores a target codeword for a data pair represented by a 2-tuple (Target_Raw_Data_Entry, Target_DSD). Therefore, each row of target encoded dataset 114 corresponds to a target raw data entry (e.g., Target_Raw_Data_Entry) in target raw dataset 112, and a row number of the row may be mapped to a location of a target raw data entry in target raw dataset 112.

In some embodiments, data encoder 120 may generate mapping data 132 that maps each row of target encoded dataset 114 to a location of a target raw data entry in target raw dataset 112. The location in target raw dataset 112 may be represented by the 2-tuple (Target_Row_Number, Target_DSD) as described before, where Target_Row_Number is a row number of the target raw data entry in target raw dataset 112, and Target_DSD is a target DSD associated with the target raw data entry. As will be discussed in details below, mapping data 132 may be used to identify sensitive data in target raw dataset 112.

Further in 304, data detection system 102 may store target encoded dataset 114 and mapping data 132 in datastore 104.

In 306, detection model 130 detects encoded sensitive data in target encoded dataset 114 and generates output dataset 116, e.g., detects a target codeword of target encoded dataset 114 that contains a component codeword that is encoded from a target raw data entry of target raw dataset 112 containing sensitive data. In some embodiments, detection model 130 may identify a subset of rows in target encoded dataset 114, and each row of the subset of rows represents a target codeword containing encoded sensitive data as predicted by detection model 130. Detection model 130 may also classify each target codeword by a sensitive data type. The sensitive data type identifies a type of sensitive data in a target raw data entry of target raw dataset 112 that is encoded into a component codeword of the target codeword. Detection model 130 may save the row numbers of the subset of rows as well as their associated sensitive data type into output dataset 116. Further in 306, data detection system 102 may store output dataset 116 in datastore 104.

In 308, correction engine 140 may retrieve output dataset 116 and mapping data 132 from datastore 104, and use output dataset 116 and mapping data 132 to identify sensitive data in target raw dataset 112. In some embodiments, output dataset 116 may include row numbers of a subset of rows of target encoded dataset 114. Each row represents a target codeword of target encoded dataset 114 containing encoded sensitive data as predicted by detection model 130, e.g., the target codeword contains a component codeword that is encoded from a target raw data entry of target raw dataset 112 containing sensitive data. Mapping data 132 stores mapping information between a row number of target encoded dataset 114 and a location of a target raw data entry in target raw dataset 112, the location is represented by a 2-tuple (Target_Row_Number, Target_DSD), where Target_Row_Number is a row number of the target raw data entry in target raw dataset 112, and Target_DSD is a target DSD associated with the target raw data entry. Therefore, a target raw data entry of target raw dataset 112, corresponding to the identified target codeword containing encoded sensitive data, can be identified as a target raw data entry containing sensitive data.

In 310, correction engine 140 applies a corrective action against the identified target raw data entries containing sensitive data in target raw dataset 112 to generate modified target dataset 118. For target raw data entries that are not detected by detection model 130 as containing sensitive data (e.g., data entries containing NPII), correction engine 140 does not change those data entries, or skip applying the corrective action to those target raw data entries. A corrective action may include masking, redaction, encryption, obfuscation or removing a data entry in a dataset, raising security levels on the dataset, or deleting the dataset together. In some embodiments, data detection system 102 may replace target raw dataset 112 with modified target dataset 118 in datastore 104. In some embodiments, data detection system 102 may delete output dataset 116 and mapping data 132 after generating modified target dataset 118.

FIG. 3B is a flowchart for an alternative method 300B for detecting and applying a corrective action to sensitive data in a target dataset using a detection model, according to some embodiments. Method 300B can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3B, as will be understood by a person of ordinary skill in the art.

Method 300B shall be described with reference to FIGS. 1 and 3B. However, method 300B is not limited to that example embodiment.

In 320, data detection system 102 receives target raw dataset 112. Target raw dataset 112 may be in a structured format (e.g., a table) and may include a plurality of target raw data entries and one or more target DSDs. A target raw data entry may include sensitive data (e.g., PII), or non-sensitive data, (e.g., NPII). Each PII, NPII and target DSD may be one or more characters including numbers, alphabets, special characters, or a combination thereof. Target raw dataset 112 may be stored in datastore 104.

In 322, data encoder 120 encodes a column of target raw data entries of target raw dataset 112 using the one-way encoding function and the two-way context encoding function to generate encoded data entries of the column, e.g., a plurality of target codewords for the column of target raw data entries in target raw dataset 112. Encoding is based on the same method as described in step 304 of FIG. 3A. The plurality of target codewords may contain encoded sensitive data, e.g., encoded PII data.

In 324, detection model 130 may detect that the plurality of target codewords for the column of target raw data entries in target raw dataset 112 contain encoded sensitive data, e.g., the column of target raw data entries contain sensitive data. Detection model 130 may further classify the sensitive data by a type of sensitive data and generate the type of sensitive data as the output, which may be saved to output dataset 116.

In 326, data detection system 102 may update metadata of target raw dataset 112 by adding the type of sensitive data associated with the column. The metadata of target raw dataset 112 may be stored in a separate database accessible to data detection system 102. In some embodiments, updating the metadata includes tagging the column of target raw dataset 112 with the type of sensitive data.

In 328, if data detection system 102 determines that more columns of target raw data entries exist in target raw dataset 112, method 300B continues at 322. Otherwise, method 300B continues at 330.

In 330, correction engine 140 applies a corrective action against the identified columns of target raw data entries containing sensitive data in target raw dataset 112 to generate modified target dataset 118 based on the metadata of target raw dataset 112. For columns of target raw data entries that are not detected by detection model 130 as containing sensitive data (e.g., data entries containing NPII), correction engine 140 does not change those data entries, or skip applying the corrective action to those columns of target raw data entries. A corrective action may include masking, redaction, encryption, obfuscation or removing a data entry in a dataset, raising security levels on the dataset, or deleting the dataset together. In some embodiments, data detection system 102 may replace target raw dataset 112 with modified target dataset 118 in datastore 104. In some embodiments, data detection system 102 may delete output dataset 116 after generating modified target dataset 118.

It should be apparent to those of ordinary skill in the art that method 300B may be implemented using a parallel architecture, so that steps 322~326 may be performed in parallel.

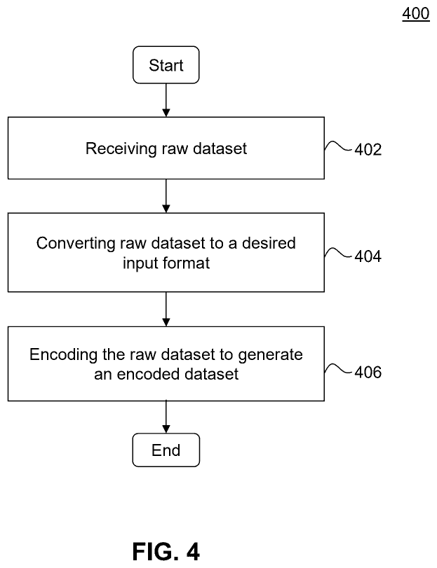

FIG. 4 is a flowchart for a method 400 for preparing input data for the detection model, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIGS. 1 and 4. However, method 400 is not limited to that example embodiment.

In 402, data detection system 102 receives raw dataset. In some embodiments, the raw dataset is training raw dataset 106. In some embodiments, the raw dataset is target raw dataset 112.

In 404, data detection system 102 converts the raw dataset to a desired format. In some embodiments, the raw dataset may be a table with one or more rows of raw data entries and one or more columns, and each column is identified by a DSD. The location of a raw data entry in the raw dataset may be uniquely identified by a 2-tuple (Row_Number, DSD), where Row_Number is a row number of the raw data entry in the raw dataset and DSD is a DSD associated with the raw data entry in the raw dataset.

In some embodiments, data detection system 102 may convert each raw data entry of the raw dataset into a data pair represented by a 2-tuple (Raw_Data_Entry, DSD), where Raw_Data_Entry is the respective raw data entry of the raw dataset and DSD is a DSD associated with the respective raw data entry.

In 406, data encoder 120 encodes each data pair to generate an encoded dataset using a one-way encoding function and a two-way context encoding function. For example, data encoder 120 encodes Raw_Data_Entry of the respective data pair using the one-way encoding function to generate a codeword for Raw_Data_Entry, and encodes DSD of the respective data pair using the two-way context encoding function to generate a component codeword for DSD. The codeword for Raw_Data_Entry and the codeword for DSD are concatenated to generate a codeword for the respective data pair. In some embodiments, both codewords are padded with zeros before being concatenated. In some embodiments, the encoded dataset is training encoded dataset 108. In some embodiments, the encoded dataset is target encoded dataset 114.

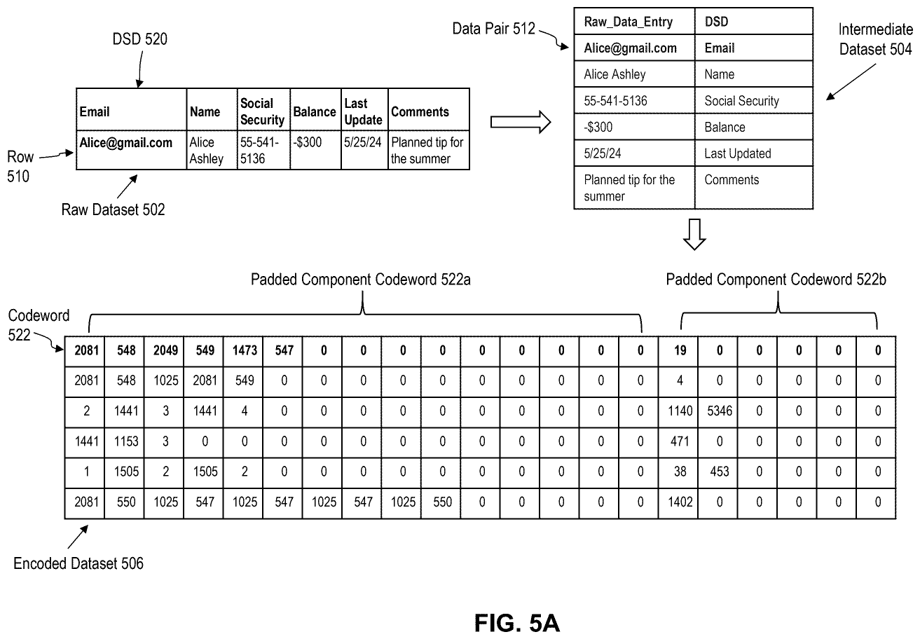

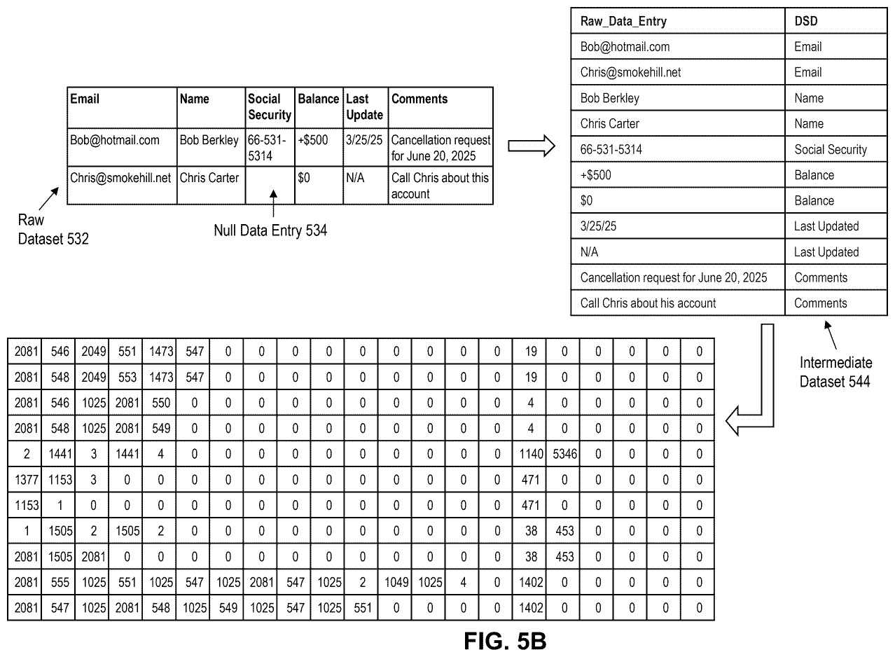

FIG. 5A is a block diagram illustrating how a data encoder may convert a raw dataset to an encoded dataset for a detection model, according to some embodiments. FIG. 5A is described with reference FIGS. 1-4. However, FIG. 5A is not limited to that example embodiment.

As described with regard to FIGS. 1-4, data encoder 120 may prepare and encode a raw dataset to generate encoded dataset as input for detection model 130. Encoding may be based on a one-way encoding function so that encoded data cannot be used to derive the raw dataset. Data encoder 120 may receive raw dataset 502. In some embodiments, raw dataset 502 is training raw dataset 106. In some embodiments, raw dataset 502 is target raw dataset 112. Raw dataset 502 may be in a structure format with one or more rows of raw data entries and one or more columns, and each column is identified by a DSD. Each data entry and each DSD may be one or more characters including numbers, alphabets, special characters, or a combination thereof.

For example, DSD 520 has a value “email”, which identifies raw data entries of the first column in raw dataset 502. In the example illustrated in FIG. 5A, raw dataset 502 has one row (e.g., row 510) and six columns. Row 510 includes six raw data entries each identified by a DSD, e.g., email “Alice@gmail. com”, name “Alice Ashley”, social security “55-541-5136”, last update date “May 25, 2024”, and comments “Planned tip for the summer”. It is to be appreciated that raw dataset 502 illustrated in FIG. 5A is only an example, and raw dataset 502 may take other forms of structures, with different number of rows and columns.

In some embodiments, data encoder 120 converts each raw data entry of raw dataset 502 to a data pair represented by (Raw_Data_Entry, DSD) to generate a set of data pairs. In some embodiments, the set of data pairs are stored in intermediate dataset 504. Each row of intermediate dataset 504 represents a data pair (Raw_Data_Entry, DSD) generated from raw dataset 502. For example, first row of intermediate dataset 504 presented data pair 512 (Alice@gmail.com, Email), which corresponds to the raw data entry “Alice@gmail.com” of raw dataset 502. The six raw data entries of raw dataset 502 are converted to six data pairs.

In some embodiments, data encoder 120 may encode each data pair of the set of data pairs using a one-way encoding function and a two-way context encoding function to generate encoded dataset 506. For example, for data pair 512, Raw_Data_Entry has a value “Alice@gmail.com”, which is encoded into a codeword of [2081, 548, 2049, 549, 1473, 547] using the one-way encoding function. DSD has a value “Email”, which is encoded into a codeword of [19] using the two-way context encoding function. In the example illustrated in FIG. 5A, the codeword for Raw_Data_Entry is an integer vector of length 10 and the codeword for DSD is an integer vector of length 1. Both codewords are padded before being concatenated to form codeword 522, which is stored in a row of encoded dataset 506.

Referring back to FIG. 5A, each row of encoded dataset 506 represents a codeword of length N integer array. For example, codeword 522 is a length 21 integer vector including padded component codeword 522a and padded component codeword 522b. Padded component codeword 522a is generated by adding five zero paddings to a codeword for raw data entry “Alice@gmail.com,” and padded component codeword 522b is generated by adding five zero paddings to a codeword for DSD “Email.” It is to be appreciated to those of ordinary skill in the art that the length of codeword may be different from what is illustrated in FIG. 5A. In some embodiments, encoded dataset 506 is training encoded dataset 108. In some embodiments, encoded dataset 506 is target encoded dataset 114. The encoding process using the one-way encoding function and the two-way context encoding function are further detailed below in FIG. 6.

FIG. 5B is a block diagram illustrating another example of how a data encoder may convert a raw dataset to an encoded dataset for a detection model, according to some embodiments. FIG. 5B is described with reference FIG. 1-4. However, FIG. 5B is not limited to that example embodiment.

FIG. 5B illustrates another example of raw dataset 532 having two rows of raw data entries and six columns. In some embodiments, a raw data entry of raw dataset 532 may have a value NULL, e.g., Null Data Entry 534. Data encoder 120 may skip Null Data Entry 534 when converting raw data entries of raw dataset 532 to data pairs of (Raw_Data_Entry, DSD) stored in intermediate dataset 544.

FIG. 6 is a flowchart for a method 600 for encoding a data pair using a one-way encoding function and a two-way context encoding function, according to some embodiments. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art.

Method 600 is described with reference FIGS. 1, 5A, 5B and 6. However, method 600 is not limited to that example embodiment.

In 602, data encoder 120 receives a data pair (Raw_Data_Entry, DSD) with value (martin@geico.com, Email_Address). The data pair may be generated from a raw data entry of a raw dataset. The raw dataset may be training raw data entry of training raw dataset 106, or a target raw data entry of target raw dataset 112. Method 600 continues at 604 and 618.

In 604, data encoder 120 replaces characters in Raw_Data_Entry (e.g., “martin@geico.com”) with integer values. For example, ASCII values. In some embodiments, data encoder 120 replaces each upper case letter character to the ASCII value of “A”, i.e., 65, each lower case letter character to the ASCII value of “a”, i.e., 17, and each numeric character to the ASCII value of “0”, i.e., 48. Additionally, each special character is replaced with its unique ASCII value, e.g., “@” is replaced with 64, “.” is replaced with 46, etc. Accordingly, data encoder 120 replaces “martin@geico.com” with a string of ASCII values of “[17, 17, 17, 17, 17, 17, 64, 17, 17, 17, 17, 46, 17, 17, 17].”

In 606, data encoder 120 encodes the ASCII value string using a run-length encoding function to generate a set of integer pairs, each integer pair includes a replaced character value and a character count. In some embodiments, the run-length encoding function generates the replaced character value and the character count as follows: starting from the beginning of the ASCII value string, setting the first ASCII value as a first replaced character value, counting the number of consecutive first replaced character values, until hitting a new ASCII value, and generating a first character count as the counted number. Next, setting the new ASCII value as a second replaced character value, and counting the number of consecutive second replaced character values. The process continues until the whole ASCII value string is traversed. For example, a portion of ASCII string “[17, 17, 17, 17, 17, 17]” is encoded by an integer pair (17, 6) since the ASCII value “17” appears consecutively 6 times. Here “17” is a replaced character value and “6” is a character count. Similarly, since the ASCII value “64” appears only once, it is encoded by an integer pair (64, 1). In the example illustrated in FIG. 6. The ASCII value string is encoded to a set of integer pairs: [(17, 6), (64, 1), (17, 5), (46, 1), (17, 3)].

Steps 608-612 of method 600 illustrate an example of a bit-wise encoding function to further encode the set of integer pairs. The bit-wise encoding function may be a function that performs one or more bit-wise encoding operations on a bit string, a bit array, or a binary numeral. For example, the bit-wise encoding function may perform one or more bit-wise encoding operations on binary representations of the set of integer pairs. It is to be appreciated that not all steps may be needed to perform the disclosure provided herein. Further, some of the steps may be performed simultaneously, or in a different order than shown in FIG. 6, as will be understood by a person of ordinary skill in the art.

In 608, for each integer pair of the set of integer pairs, data encoder 120 converts each replaced character value of the respective integer pair into a binary format of the replaced character value and each character count of the respective integer pair into a binary format of the character count. For example, for the first integer pair (17, 6) of the set of integer pairs, the replaced character value “17” is converted to its binary format of “10001”, and the character count “6” is converted to its binary format of “110”.

In 610, for each integer pair of the set of integer pairs, data encoder 120 applies an M-bit left shifting to the binary format of the replaced character value of the respective integer pair, and combining the shifted binary format of the replaced character value and the binary format of the character count of the respective pair. In the example illustrated in FIG. 6, M is an integer and M=5. The binary format of the replaced character value of the first integer pair “10001” is left shifted by 5 bits as “1000100000”, which is then combined with the binary format of the character count of the first integer pair “110” to generate “1000100110”.

In some embodiments, M may be configured to be at least the maximum number of binary bits for character count so that after the combining, the binary bits of the shifted binary format of the replaced character value do not overlap with the binary bits of the binary format of the character count. In some embodiments, combining includes summing.

In 612, for each integer pair of the set of integer pairs, the combined shifted binary format of the replaced character and the binary format of the character count is converted into a decimal format. For example, for the first integer pair (17, 6), the combined binary format is “1000100110” based on step 610, which is then converted to a decimal format of 550. Therefore, 550 is an encoded datum for the first integer pair (17, 6). The encoded datum may be an integer value that constitutes a portion of a codeword for Raw_Data_Entry. The codeword for Raw_Data_Entry “martin@geico.com” is generated by combining all encoded datum for the set of integer pairs, which is “[550, 2049, 549, 1473, 547],” or an integer vector of length 5.

Steps 618-622 of method 600 illustrate an example of a two-way context encoding function to encode a DSD of the received data pair.

In 618, data encoder 120 extracts one or more words from the DSD by removing any punctuation, and converting any upper case letter to lower case letter, where each word is a collection of alphabetical characters. In some embodiments, a DSD may be a combination of one or more words, and the one or more words may be connected by special characters. By extracting the one or more words from the DSD, the context information can be preserved. In the example illustrated in FIG. 6, two words, e.g., “email” and “address”, are extracted from DSD “Email Address”.

In 620, data encoder 120 encodes the one or more words using a word-based encoding scheme. For example, data encoder 120 may find a plurality of unique words across DSDs in the entire raw dataset. The raw dataset may be training raw dataset 106 or target raw dataset 112. Data encoder 120 may then sort the plurality of the unique words in order of frequency, and assign each word a unique numeric value. Once the mapping of words to numeric values is constructed, the one or more words of the DSD may be mapped to their associated numeric values in the mapping. In the example illustrated in FIG. 6, “email” is mapped to “11” and “address” is mapped to “439”. It is to be appreciated that other ways may be used to encode DSD “Email Address.”

In 622, data encoder 120 generates a codeword for the DSD by combining the numeric values of the one or more words extracted from the DSD. In the example illustrated in FIG. 6, the codeword for DSD “Email_Address” is [11, 439], or an integer vector of length 2. Since the mapping from the words to numeric values is a 1-to-1 mapping, this is a two-way encoding scheme. In other words, the original value of the DSD can be decoded from the codeword of the DSD.

In 624, data encoder 120 adds padding zeros to the codeword for Raw_Data_Entry “martin@geico.com” so that the padded codeword is an integer vector of length L1, and adds padding zeros to the codeword for DSD “Email_Address” so that the padded codeword for DSD is an integer vector of L2. Both L1 and L2 are integer values greater than 0 and are configurable to accommodate longer codewords. If a codeword for Raw_Data_Entry is longer than L1, the codeword will be truncated to length L1. Similarly, if a codeword for DSD is longer than L2, the codeword will be truncated to length L2. In the example illustrated in FIG. 6, L1 is 14 and L2 is 6. This means the longest codeword for Raw_Data_Entry is 14 and the longest codeword for DSD is 6. The padded codewords are concatenated to generate a codeword for the data pair (martin@geico.com, Email_Address). The codeword for the data pair includes a first component codeword, which is the codeword for Raw_Data_Entry of the data pair, and a second component codeword, which is the codeword for DSD of the data pair.

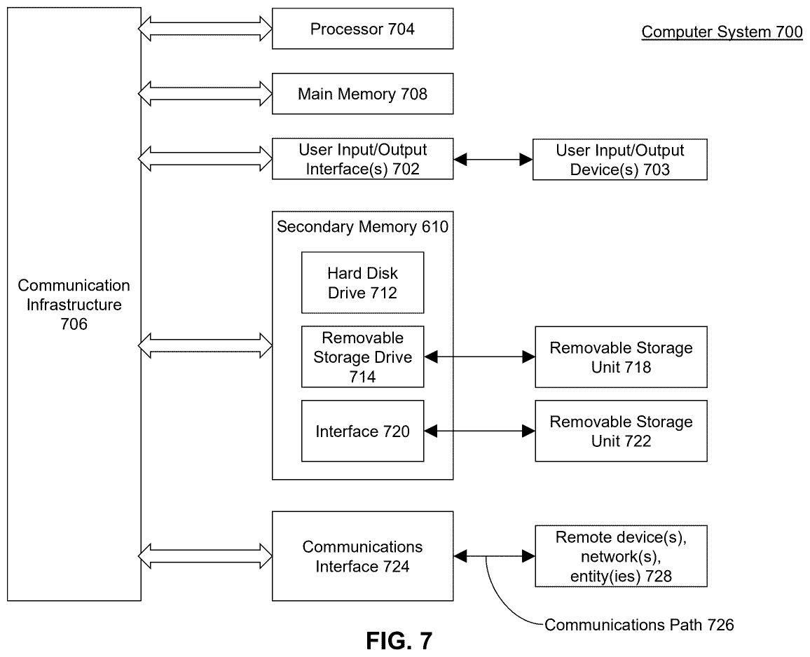

Various embodiments may be implemented, for example, using one or more well-known computer systems, such as computer system 700 shown in FIG. 7. One or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1-18. (canceled)

19. A computer-implemented, cryptographic method for detecting and applying a corrective action to personally identifiable information (PII), comprising:
encoding, by at least one processor, a training raw dataset using a one-way encoding function and a two-way context encoding function, thereby generating a training encoded dataset, wherein the training raw dataset comprising a plurality of training raw data entries and one or more training dataset descriptors (DSDs), wherein each training raw data entry of the plurality of training raw data entries comprises PII or non-PII (NPII), wherein the training encoded dataset comprises a plurality of training codewords that exclude PII, and wherein the encoding the training raw dataset comprises:
converting the training raw dataset into a plurality of data pairs, wherein each data pair of the plurality of data pairs comprises a training raw data entry of the plurality of training raw data entries and a training DSD of the one or more training DSDs; and
for each data pair of the plurality of data pairs:
generating a codeword for the training raw data entry of the respective data pair using the one-way encoding function;
generating a codeword for the training DSD of the respective data pair using the two-way context encoding function; and
generating a training codeword for the respective data pair by concatenating the codeword for the training raw data entry with the codeword for the training DSD;
training a detection model using the training encoded dataset;
generating a modified target dataset using the detection model, wherein the generating the modified target dataset comprises:
encoding a target raw dataset using the one-way encoding function and the two-way context encoding function, thereby generating a target encoded dataset, wherein the target raw dataset comprising a plurality of target raw data entries and one or more target DSDs, wherein each target raw data entry of the plurality of target raw data entries comprises PII or NPII, wherein the target encoded dataset comprises a plurality of target codewords that exclude PII, and wherein the encoding the target raw dataset comprises generating the plurality of target codewords based on the plurality of target raw data entries and the one or more target DSDs of the target raw dataset using the one-way encoding function;
detecting, using the detection model, a target codeword within the target encoded dataset, wherein the target codeword contains a component codeword that is encoded from a target raw data entry comprises PII;
generating an output dataset comprising information related to the detected target codeword;
identifying the target raw data entry comprising PII in the target raw dataset based on the output dataset; and
applying the corrective action against the target raw data entry comprising PII in the target raw dataset, thereby generating the modified target dataset.

20. The computer-implemented, cryptographic method of claim 19, wherein the PII, the NPII, the one or more training DSDs, and the one or more target DSDs comprise alphabetical, numeric, or special characters, or a combination thereof.

21. The computer-implemented, cryptographic method of claim 19, wherein the one-way encoding function irreversibly encodes a raw data entry to generate a codeword, wherein the codeword is an integer vector of length L, and wherein L is an integer greater than 0.

22. The computer-implemented, cryptographic method of claim 19, wherein the generating the codeword for the training raw data entry comprises:
replacing characters in the PII or the NPII of the each training raw data entry with integer values using a one-way mapping function to generate a string of integer values;
encoding the string of integer values using a run-length encoding function to generate a plurality of integer pairs, wherein each integer pair of the plurality of integer pairs containing a replaced character value and a character count;
for each integer pair of the plurality integer pairs:
converting the replaced character value into a binary format of the replaced character value, and the character count into a binary format of the character count;
shifting the binary format of the replaced character value a predetermined number of places to the left;
summing the shifted binary format of the replaced character value and the binary format of the character count; and
converting the summed shifted binary format of the replaced character and the binary format of the character count into a decimal format to generate an encoded datum for the respective integer pair, wherein the encoded datum constitutes a portion of the codeword for the training raw data entry; and
combining the encoded datum for each integer pair of the plurality of integer pairs to produce the codeword for the training raw data entry.

23. The computer-implemented, cryptographic method of claim 19, wherein the generating the codeword for the training DSD comprises:
extracting one or more words from the training DSD, wherein the one or more words are collections of alphabetical characters;
mapping the one or more words to one or more numeric values, wherein different words are mapped to a different numeric value; and
generating the codeword for the training DSD by combining the one or more numeric values.

24. The computer-implemented, cryptographic method of claim 19, wherein the corrective action comprises masking, redaction, encryption, obfuscation, raising security levels on the target raw dataset, removing the plurality of target raw data entry, or deleting the target raw dataset.

31-34. (canceled)

35. A computer-implemented, cryptographic method for detecting and obfuscating sensitive data, comprising:
receiving, by at least one processor, a training raw dataset with second sensitive data;
encoding the training raw dataset using a one-way encoding function, thereby generating a training encoded dataset, wherein the training encoded dataset excludes the second sensitive data;
training a detection model based on the training encoded dataset; and
generating an obfuscated target dataset using the detection model, wherein the generating the obfuscated target dataset comprises:
encoding a target raw dataset using the one-way encoding function, thereby generating a target encoded dataset, wherein the target raw dataset comprises the sensitive data, and wherein the target encoded dataset comprises encoded sensitive data;
detecting encoded sensitive data in the target encoded dataset using the detection model, thereby generating an output dataset;
identifying the sensitive data in the target raw dataset based on the output dataset; and
obfuscating the sensitive data in the target raw dataset, thereby generating the obfuscated target dataset.

36. The computer-implemented, cryptographic method of claim 35, wherein the one-way encoding function irreversibly encodes a raw data entry to generate a codeword, wherein the codeword is an integer vector of length L, and wherein L is an integer greater than 0.

37. The computer-implemented, cryptographic method of claim 35, wherein the training raw dataset is in a structured format comprising a plurality of training raw data entries and one or more training dataset descriptors (DSDs).

38. The computer-implemented, cryptographic method of claim 37, wherein the encoding the training raw dataset comprises:
converting the plurality of training raw data entries into a plurality of data pairs, wherein each data pair of the plurality of data pairs comprises a training raw data entry of the plurality of training raw data entries and a training DSD of the one or more training DSDs, wherein the training raw data entry and the training DSD comprise alphabetical, numeric, or special characters; and
for each data pair of the plurality of data pairs:
replacing characters in the training raw data entry with integer values using a one-way mapping function, thereby generating a string of integer values;
encoding the string of integer values using a run-length encoding function, thereby generating a plurality of integer pairs;
encoding the plurality of integer pairs using a bit-wise encoding function, thereby generating a codeword for the training raw data entry;
encoding the training DSD of the respective data pair using a two-way context encoding function, thereby generating a codeword for the training DSD; and
concatenating the codeword for the training raw data entry and the codeword for the training DSD, thereby generating a training codeword for the respective data pair.

39. The computer-implemented, cryptographic method of claim 38, wherein the generating the plurality of integer pairs comprises:
for each integer pair of the plurality of integer pairs:
converting a replaced character value of the respective integer pair into a binary format of the replaced character value, and a character count of the respective integer pair into a binary format of the character count;
shifting the binary format of the replaced character value a predetermined number of places to the left, thereby generating a shifted version of the binary format of the replaced character value;
combining the shifted version of the binary format of the replaced character value with the binary format of the character count; and
converting the combined shifted version of the binary format of the replaced character value and the binary format of the character count into a decimal format, thereby generating an encoded datum for the respective integer pair, wherein the encoded datum constitutes a portion of the codeword for the training raw data entry; and
combining the encoded datum for each integer pair of the plurality of integer pairs to generate the codeword for the training raw data entry.

40. The computer-implemented, cryptographic method of claim 38, wherein encoding the training DSD comprises:
extract one or more words from the training DSD, wherein the one or more words are collections of alphabetical characters;
map the one or more words to one or more numeric values, wherein different words are mapped to a different numeric value; and
generate the codeword for the training DSD by combining the one or more numeric values.

41. The computer-implemented, cryptographic method of claim 35, wherein the training the detection model further comprises:
dividing the training encoded dataset into two or more non-overlapping training encoded data subsets;
training the detection model using a first training encoded data subset, thereby generating an updated detection model;
evaluating the updated detection model using a second training encoded data subset, thereby generating a performance measurement;
generating a comparison by comparing the performance measurement with a predefined performance threshold; and
completing the training in response to the comparison that the performance measurement is greater than or equal to the predefined performance threshold.

42. The computer-implemented, cryptographic method of claim 41, wherein the performance measurement is based on a precision value and a recall value, and wherein the precision value measures a detection accuracy of the updated detection model, and wherein the recall value measures a detection rate of the updated detection model.

43. The computer-implemented, cryptographic method of claim 42, wherein the training the detection model further comprises:
training the detection model using a third training encoded data subset in response to the comparison that the performance measurement is less than the predefined performance threshold.

44. The computer-implemented, cryptographic method of claim 35, wherein the output dataset comprises a location of a target codeword containing encoded sensitive data and a sensitive data type, and wherein the identifying the sensitive data in the target raw dataset comprises identifying a location of sensitive data in the target raw dataset based on the location of the target codeword containing encoded sensitive data.

45. The computer-implemented, cryptographic method of claim 35, wherein the sensitive data includes personally identifiable information (PII).

46. A system for detecting and applying a corrective action to personally identifiable information (PII), comprising:
one or more memories configured to store:
a training raw dataset comprising a plurality of training raw data entries and one or more training dataset descriptors (DSDs), wherein each training raw data entry of the plurality of training raw data entries comprises personally identifiable information (PII) or non-PII (NPII); and
a target raw dataset comprising a plurality of target raw data entries and one or more target DSDs, wherein each target raw data entry of the plurality of target raw data entries comprises PII or NPII; and
at least one processor each coupled to at least one of the memories and configured to perform operations comprising:
encoding the training raw dataset using a one-way encoding function and a two-way context encoding function, thereby generating a training encoded dataset, wherein the training encoded dataset comprises a plurality of training codewords that exclude PII, and wherein the encoding the training raw dataset comprises:
converting the training raw dataset into a plurality of data pairs, wherein each data pair of the plurality of data pairs comprises a training raw data entry of the plurality of training raw data entries and a training DSD of the one or more training DSDs; and
for each data pair of the plurality of data pairs:
generating a codeword for the training raw data entry of the respective data pair using the one-way encoding function;
generating a codeword for the training DSD of the respective data pair using the two-way context encoding function; and
generating a training codeword for the respective data pair by concatenating the codeword for the training raw data entry with the codeword for the training DSD;
training a detection model using the training encoded dataset;
generating a modified target dataset using the detection model, wherein the generating the modified target dataset comprises:
encoding the target raw dataset using the one-way encoding function and the two-way context encoding function, thereby generating a target encoded dataset, wherein the target encoded dataset comprises a plurality of target codewords that exclude PII, and wherein the encoding the target raw dataset comprises generating the plurality of target codewords based on the plurality of target raw data entries and the one or more target DSDs of the target raw dataset using the one-way encoding function and the two-way context encoding function;
detecting, using the detection model, a target codeword within the target encoded dataset, wherein the target codeword contains a component codeword that is encoded from a target raw data entry comprising PII;
generating an output dataset comprising information related to the target codeword;
identifying the target raw data entry comprising PII in the target raw dataset based on the output dataset; and
applying the corrective action against the target raw data entry comprising PII in the target raw dataset, thereby generating the modified target dataset.

47. The system of claim 46, wherein the PII, the NPII, the one or more training DSDs, and the one or more target DSDs comprise alphabetical, numeric, or special characters, or a combination thereof.

48. The system of claim 46, wherein the one-way encoding function irreversibly encodes a raw data entry to generate a codeword, wherein the codeword is an integer vector of length L, and wherein L is an integer greater than 0.

49. The system of claim 46, wherein the generating the codeword for the training raw data entry comprises:
replacing characters in the PII or the NPII of the each training raw data entry with integer values using a one-way mapping function to generate a string of integer values;
encoding the string of integer values using a run-length encoding function to generate a plurality of integer pairs, wherein each integer pair of the plurality of integer pairs containing a replaced character value and a character count;
for each integer pair of the plurality integer pairs:
converting the replaced character value into a binary format of the replaced character value, and the character count into a binary format of the character count;
shifting the binary format of the replaced character value a predetermined number of places to the left;
summing the shifted binary format of the replaced character value and the binary format of the character count; and
converting the summed shifted binary format of the replaced character and the binary format of the character count into a decimal format to generate an encoded datum for the respective integer pair, wherein the encoded datum constitutes a portion of the codeword for the training raw data entry; and
combining the encoded datum for each integer pair of the plurality of integer pairs to produce the codeword for the training raw data entry.

50. The system of claim 49, wherein the replacing the characters in the PII and the NPII comprises:
replacing a upper-case alphabetical character with a first integer value, a lower-case alphabetical character with a second integer value, or a special character with a unique integer value different from the first integer value or the second integer value.

51. The system of claim 46, wherein the generating the codeword for the training DSD comprises:
extracting one or more words from the training DSD, wherein the one or more words are collections of alphabetical characters;
mapping the one or more words to one or more numeric values, wherein different words are mapped to a different numeric value; and
generating the codeword for the training DSD by combining the one or more numeric values.

52. The system of claim 46, wherein the corrective action comprises masking, redaction, encryption, obfuscation, raising security levels on the target raw dataset, removing the plurality of target raw data entry, or deleting the target raw dataset.

53. A non-transitory computer-readable medium having instructions stored thereon that, when executed by at least one computing device, cause the at least one computing device to perform operations comprising:
encoding a training raw dataset using a one-way encoding function and a two-way context encoding function, thereby generating a training encoded dataset, wherein the training raw dataset comprising a plurality of training raw data entries and one or more training dataset descriptors (DSDs), wherein each training raw data entry of the plurality of training raw data entries comprises personally identifiable information (PII) or non-PII (NPII), wherein the training encoded dataset comprises a plurality of training codewords that exclude PII, and wherein the encoding the training raw dataset comprises:
converting the training raw dataset into a plurality of data pairs, wherein each data pair of the plurality of data pairs comprises a training raw data entry of the plurality of training raw data entries and a training DSD of the one or more training DSDs; and
for each data pair of the plurality of data pairs:
generating a codeword for the training raw data entry of the respective data pair using the one-way encoding function;
generating a codeword for the training DSD of the respective data pair using the two-way context encoding function; and
generating a training codeword for the respective data pair by concatenating the codeword for the training raw data entry with the codeword for the training DSD;
training a detection model using the training encoded dataset;
generating a modified target dataset using the detection model, wherein the generating the modified target dataset comprises:
encoding a target raw dataset using the one-way encoding function and the two-way context encoding function, thereby generating a target encoded dataset, wherein the target raw dataset comprising a plurality of target raw data entries and one or more target DSDs, wherein each target raw data entry of the plurality of target raw data entries comprises PII or NPII, wherein the target encoded dataset comprises a plurality of target codewords that exclude PII, and wherein the encoding the target raw dataset comprises generating the plurality of target codewords based on the plurality of target raw data entries and the one or more target DSDs of the target raw dataset using the one-way encoding function;
detecting, using the detection model, a target codeword within the target encoded dataset, wherein the target codeword contains a component codeword that is encoded from a target raw data entry comprises PII;
generating an output dataset comprising information related to the detected target codeword;
identifying the target raw data entry comprising PII in the target raw dataset based on the output dataset; and
applying a corrective action against the target raw data entry comprising PII in the target raw dataset, thereby generating the modified target dataset.

54. The non-transitory computer-readable medium of claim 53, wherein the PII, the NPII, the one or more training DSDs, and the one or more target DSDs comprise alphabetical, numeric, or special characters, or a combination thereof.

55. The non-transitory computer-readable medium of claim 53, wherein the one-way encoding function irreversibly encodes a raw data entry to generate a codeword, wherein the codeword is an integer vector of length L, and wherein L is an integer greater than 0.

56. The non-transitory computer-readable medium of claim 53, wherein the generating the codeword for the training raw data entry comprises:
replacing characters in the PII or the NPII of the each training raw data entry with integer values using a one-way mapping function to generate a string of integer values;
encoding the string of integer values using a run-length encoding function to generate a plurality of integer pairs, wherein each integer pair of the plurality of integer pairs containing a replaced character value and a character count;
for each integer pair of the plurality integer pairs:
converting the replaced character value into a binary format of the replaced character value, and the character count into a binary format of the character count;
shifting the binary format of the replaced character value a predetermined number of places to the left;
summing the shifted binary format of the replaced character value and the binary format of the character count; and
converting the summed shifted binary format of the replaced character and the binary format of the character count into a decimal format to generate an encoded datum for the respective integer pair, wherein the encoded datum constitutes a portion of the codeword for the training raw data entry; and
combining the encoded datum for each integer pair of the plurality of integer pairs to produce the codeword for the training raw data entry.

57. The non-transitory computer-readable medium of claim 53, wherein the generating the codeword for the training DSD comprises:
extracting one or more words from the training DSD, wherein the one or more words are collections of alphabetical characters;
mapping the one or more words to one or more numeric values, wherein different words are mapped to a different numeric value; and
generating the codeword for the training DSD by combining the one or more numeric values.

58. The non-transitory computer-readable medium of claim 53, wherein the corrective action comprises masking, redaction, encryption, obfuscation, raising security levels on the target raw dataset, removing the plurality of target raw data entry, or deleting the target raw dataset.
